(19) United States
(12) Patent Application Publication
(10) Pub. No.: US 2025/0228233 A1
(43) Pub. Date: Jul. 17, 2025

(54) Scent Luring Apparatus

(71) Applicant: Ghost Drag, LLC, Dillon, CO (US)

(72) Inventors: Jacob Versailles, Dillon, CO (US); Jennifer Versailles, Dillon, CO (US)

(21) Appl. No.: 19/011,817

(22) Filed: Jan. 7, 2025

Related U.S. Application Data
(60) Provisional application No. 63/620,243, filed on Jan. 12, 2024.

(51) Int. Cl. A01M 31/00; F41B 3/02

(52) U.S. Cl. CPC A01M 31/008; F41B 3/02

(57) ABSTRACT

A scent luring apparatus is disclosed, which includes a scent pod containing a scented material and a scent delivery mechanism designed to launch the scent pod to a remote location. Upon impact, the scent pod is configured to at least partially open, thereby releasing at least some of the scented material. An example scent pod includes a casing with a filling, where the filling is a scented material that retains and disperses the scent upon opening of the outer shell. An example scent delivery mechanism includes a launching device with a handle, at least one arm attached to the handle, at least one retention cord attached to the arm, and a pouch. Alternatively, the scent delivery mechanism could be an air gun, a bow and arrow, a crossbow and bolt, or a slingshot, or even be hand delivered (e.g., by tossing), providing flexibility in deploying the scent pods.

### PRIORITY CLAIM

This application claims the priority filing benefit of U.S. Provisional Patent Application No. 63/620,243 filed Jan. 12, 2024 for “Scent Luring Device” of Jacob Versailles and Jennifer Versailles, hereby incorporated by reference in its entirety as though fully set forth herein.

### BACKGROUND

It may be desired when hunting to provide a scent to attract wild animals being hunted to an area and/or to mask the scent of people in the area. While the human scent may or may not be detectable to people, it is almost always detected by animals. Therefore, it can be counterproductive for a hunter to walk into an area to spread the scent, because some human scent will likely also be left in the area. Nearly any human scent at all will set deer and other wild animals on high alert and may completely deter the wild animal(s) from entering the area.

Scent can significantly influence success during hunting. Deer and many other animals have an extraordinary sense of smell. They can detect human scent from a long distance, often causing them to flee before a hunter even spots them. This heightened olfactory sense is a key survival mechanism for these animals. Wind also plays a critical role in scent detection. If the wind carries a hunter's scent towards the animal, it will likely become alert and cautious. Experienced hunters always consider wind direction and try to position themselves downwind of their prey.

Human scent isn't just about sweat. It includes scents from various activities and products, such as soaps, detergents, deodorants, and even the food a hunter consumes. These scents can easily be picked up by sensitive noses in the wild.

Scent control routines hunters use involve meticulous care to minimize scent, such as showering with scent-free soap, washing hunting clothes in scent-free detergent, and storing gear in airtight containers with natural materials like leaves or cedar chips.

Sometimes, hunters will use cover scents and scent-blocking. Cover scents emit strong, natural odors (including pine, musk, and even urine). These are intended to overwhelm any remaining human scents without alarming the deer or other animals being hunted. Scent-blocking sprays, clothing, and gear are designed to absorb or neutralize the odors that hunters emit. Activated carbon and silver nanoparticles are common technologies used in scent-blocking gear.

No amount of scent control will completely eliminate a hunter's odor.

### BRIEF DESCRIPTION OF THE DRAWINGS

FIG. 1 is an isometric view of an example scent luring apparatus having a scent pod and a launching device.

FIG. 2 is a close-up isometric view of a pouch of the launching device.

FIG. 3 is a front view of the pouch of the launching device shown in FIG. 2.

FIG. 4 is a side view of the pouch of the launching device shown in FIG. 2.

FIG. 5 shows an example scent pod.

FIG. 6 illustrates loading the scent pod into the pouch of the launching device.

FIG. 7 illustrates drawing the launching device.

FIG. 8 is a top down view of the pouch of the drawn launching device corresponding to FIG. 7.

### DETAILED DESCRIPTION

The key to hunting, trapping, and training is to outsmart the animal's nose. Most missed opportunities in the field when hunting or trapping are because the animal smells or sees you. Artificial scents can play a role in a successful hunt. Artificial scents may be employed as scent decoys, such as pheromones or glandular scents from other animals. For example, during the rut (mating season), deer hunters might use doe estrus scents to attract bucks. These decoys can help lure animals closer to the hunter's position. But spreading these scents near the hunting area without also introducing human scent (e.g., when walking around distributing the attractant scent) has been a problem.

A scent luring apparatus is disclosed herein which enables a scent to be delivered to a location that is remote from the hunter, without the hunter having to walk into that area to deliver the scent. The scent luring apparatus includes a scent pod containing a scented material and a scent delivery mechanism designed to launch the scent pod to a remote location. Upon impact, the scent pod is configured to at least partially open, thereby releasing at least some of the scented material into the surrounding environment to serve as an attractant to deer and other animals being hunted.

The scent pod includes a casing with a filling or substance. In an example, the filling or substance is a scented material that retains so that the scent is dispersed with the scented material upon opening of the outer shell to release the scented material.

The scent delivery mechanism can be configured as a launching device. An example of a launching device includes a handle, at least one arm attached to the handle, at least one retention cord attached to the arm, and a pouch. Other scent delivery mechanisms are also contemplated for use with the scent pods disclosed herein. For example, the scent delivery mechanism can be an air gun, a bow and arrow, a crossbow and bolt, or a slingshot. In another example, the scent delivery mechanism can even involve hand delivering (e.g., by tossing or throwing the scent pod), providing flexibility in deploying the scent pods.

In an example, the scent luring apparatus may be implemented to put whatever animal scent or lure that is chosen (e.g., deer, elk, bobcat, etc.) out into the field, without contamination of human scent or being detected. The scent luring device may be implemented for attracting game for hunting or trapping, as well as for training dogs.

The scent luring apparatus assists hunters in attracting deer by launching scent pods into the surrounding woods. The apparatus includes a scent pod filled with a biodegradable scented material and a delivery mechanism capable of propelling the pod to remote locations. Upon impact, the scent pod partially opens, dispersing the scent effectively. Various implementations include using different materials for the pod's casing, such as gelatin or polyethylene glycol, and ensuring the scented material is nontoxic and eco-friendly. This versatile device can be launched using multiple mechanisms like air guns, bows and arrows, crossbows, and slingshots, catering to hunters' preferences and needs.

Additionally, the apparatus offers advanced features for enhanced usability, including a launching device with a handle, retention cord, and pouch designed to hold and launch the scent pod. Some versions incorporate a chamber for storing extra pods and support structures like forearm braces for stability. The retention cords can be configured with different bands to indicate varying elasticity levels, allowing hunters to customize the launch force. This innovative device provides an efficient and environmentally conscious solution for hunters seeking to lure deer during hunting season.

The scent luring device eliminates the need for the hunter to contaminate the area by walking around and hanging scent applicators in trees or doing a scent drag (e.g., dragging a piece of cloth with scent on it attached to a string being drug on the ground). Instead, the scent luring device disclosed herein includes a polyethylene glycol pod that has the scent(s) to be dispersed. The scent pod can be delivered to a desired area by tossing or using a pouch of the launching device with a special pouch made for the scent pod, although other devices such as air guns, bow and arrow or crossbows, and even hand delivery (e.g., tossing) can be used for delivery of the scent pods disclosed herein.

The specially designed pouch on the pouch of the launching device can be configured specific to the scent pod(s) being used, allowing the user to shoot the scent pod without breaking the pod with their fingers. The pouch of the launching device can also be fitted with different strength bands for different users (e.g., for men, women and youths) making it easier or harder to pull back and/or applications (e.g., range or distance).

Regardless of the mode of delivery, the scent pod breaks on impact and disperses the scent in the desired area. The pod itself may be nontoxic and biodegradable. The scent luring device enables hunters, trappers, and trainers to shoot the scent pod into a desired area to disperse the scent without the person or hunter walking into the hunting or training area.

The scent luring device offers simplicity and ease of use, effectiveness, cleanliness, and is environmentally-friendly. Hunters no longer have to struggle with bottles of urine, lures, or other scents that may otherwise open and spill, or drip on your hands or clothing. There should be no more leaks in the hunting bag, and the users do not smell the scent as it is delivered away from the user before being dispersed.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

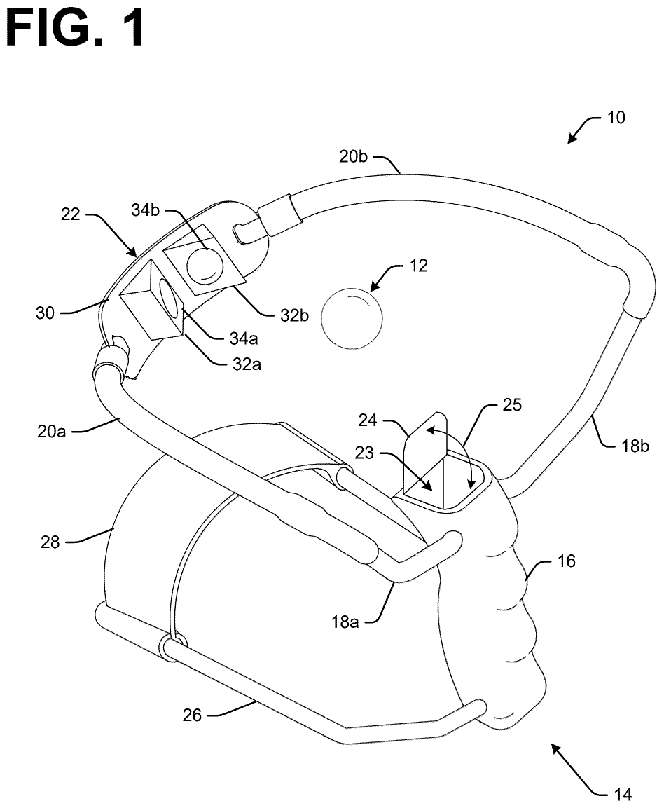

FIG. 1 is an isometric view of an example scent luring apparatus 10 having a scent pod 12 and a launching device 14. An example scent pod 12 includes a scented material. The scent pod 12 is configured to at least partially or fully open upon impact, releasing a portion of the scented material into the surrounding environment. Examples of scented material can include various biodegradable substances infused with various scents depending at least in part on the purpose (e.g., as an attractant for hunting, for training hunting dogs, etc.).

It is noted that although the delivery system is described herein with reference to the launching device 14 shown in FIG. 1 (e.g., a slingshot-type device) for purposes of illustration, the scent pod 12 may be delivered by other device(s) and/or means. Examples of delivery mechanisms include, but are not limited to propulsion systems such as pneumatic cannons or even motorized launchers. Other examples include, but are not limited to, an air gun, paintball gun, traditional slingshot, a bow and arrow, crossbow and bolts, and even by hand delivery (e.g., throwing or tossing the scent pod). Each type requires a different approach to launching the scent pod 12 effectively. For example, an air gun uses a pressure system, while a bow and arrow would rely on tension and elasticity. Substitutes for these mechanisms can include hand-held catapults or even drone-based systems for more precise delivery.

Implementing such a device requires a robust design for both the scent pod 12 and the delivery mechanism to ensure that the pod can be accurately launched and that it opens correctly on impact. An example launching device 14 is shown in FIG. 1 as it includes a handle 16, one or more arms 18a, 18b, one or more retention cords 20a, 20b, and a pouch 22.

The retention cords 20a, 20b can be configured with different bands (e.g., having various elasticity, length, durability, etc.). This allows for easy customization of the launching device 14, e.g., by providing various launch forces. In an example, each band visually indicates the elasticity of the band by color. Substitutes for this feature can include using numbering or other labels, or even bands with different textures to indicate varying elasticity levels. In an example, the bands can be configured to be more readily drawn back by women and/or youths. The band can also be configured for longer or shorter range firing.

In an example, the handle 16 includes a chamber 23 with a lid 24 that can be opened and closed (e.g., as illustrated by arrows 25), for storing the scent pod 12 inside the handle 16. This feature adds convenience by providing a secure storage option within the launching device 14. Other examples for storing the scent pods 12 along with the launching device 14 can include external storage compartments or clip-on holders that attach to the handle 16 or elsewhere.

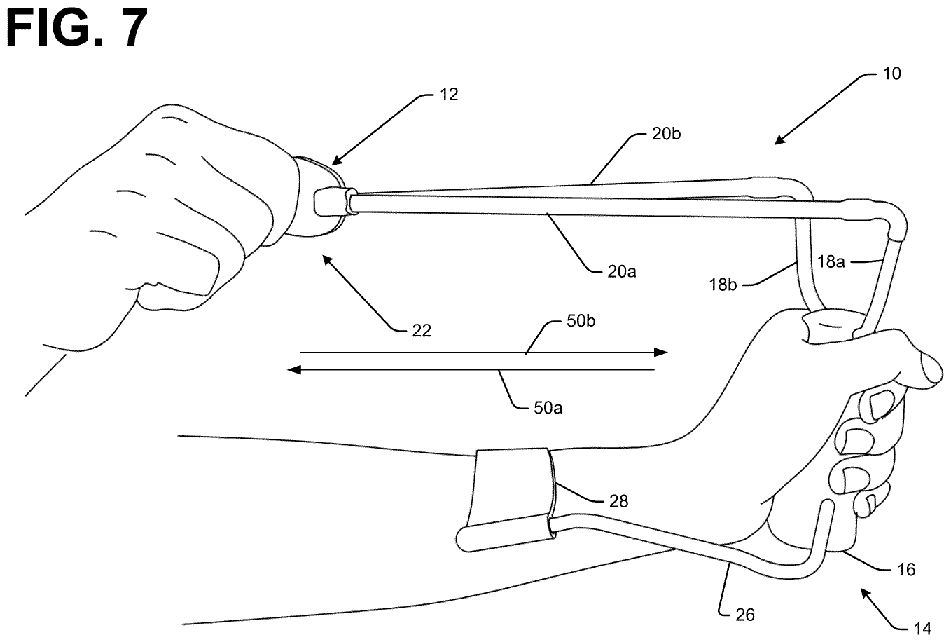

In an example, the launching device 14 includes a support structure 26 and a brace member 28. The support structure 26 and brace member 28 fit adjacent to the user's forearm during use (see, e.g., FIG. 7). A strap (not shown) may also be provided in other examples to go around the user's forearm and strap it thereto. The support structure 26 and brace 28 help provide stability and ease of use during launching of the scent pod 12. The support structure 26 and brace 28 may have an ergonomic design to help ensure user comfort and effectiveness. Alternatives can include adjustable braces or modular designs that can be customized to fit different users.

Before continuing, it is noted that the structure of the launching device 14 is not limited to that which is shown in the drawings. For example, different types of handles 16 may be provided for ergonomics, or various configurations of the arms 18a, 18b, and retention cords 20a, 20b may be provided based on design considerations such as, but not limited to, the end-user (e.g., adult/child, man/woman), operational considerations (e.g., where and when the scent pod is being launched), and durability.

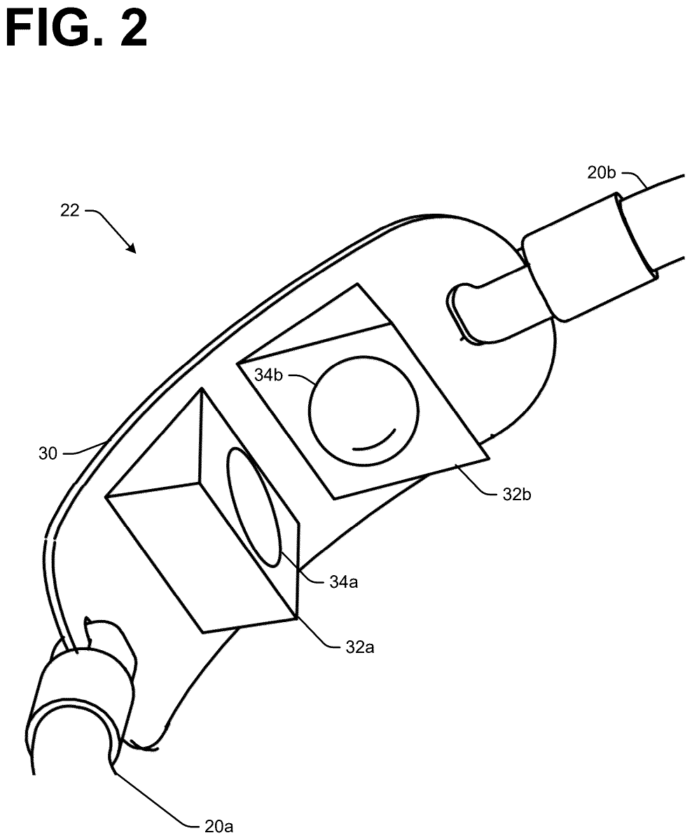

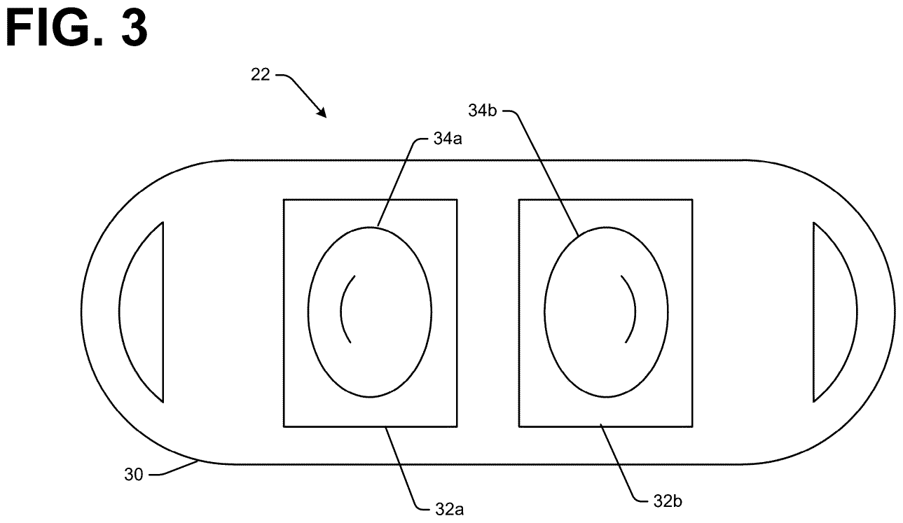

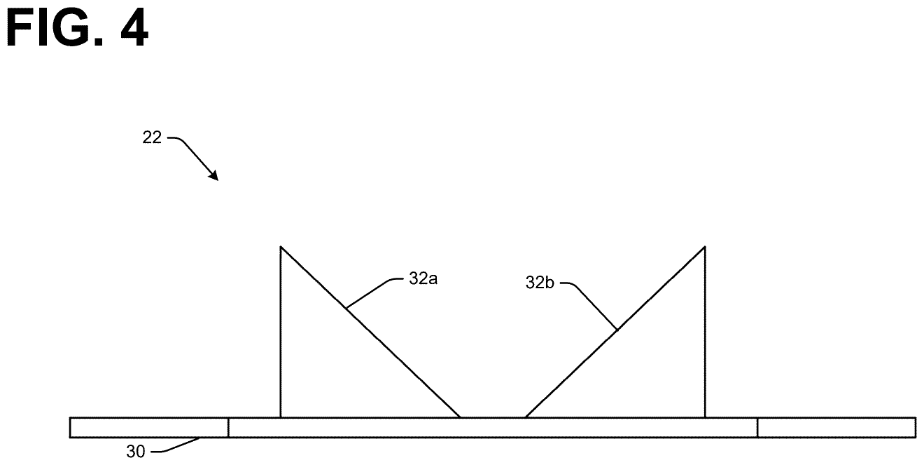

FIG. 2 is a close-up isometric view of a pouch 22 of the launching device 14. FIG. 3 is a front view of the pouch 22 of the launching device 14 shown in FIG. 2. FIG. 4 is a side view of the pouch 22 of the launching device 14 shown in FIG. 2. The pouch 22 includes a base member 30 attached to the retention cords 20a, 20b, providing stability and control during the launch. The base member 30 can be made from various durable materials such as reinforced fabric. leather, flexible plastics or lightweight composites that balance strength and flexibility. One or more pod structures 32a, 32b are provided on the base member 30 of the pouch 22. The pod structures 32a, 32b may be formed of rubber or other material to provide a structure for one or more pod pockets 34a, 34b.

In an example, the pod pockets 34a, 34b are configured to receive the scent pod 12 at least partially therein, for launching the scent pod 12 (or multiple pods simultaneously) from the pouch 22 of the launching device 14 during operation. The pod pockets 34a, 34b can be configured to receive different sizes (e.g., 50 or 68 caliber) and/or shapes of scent pods 12 are not limited to the “cup” configuration shown for the spherical scent pod 12. For example, the pod pockets 34a, 34b may be square, triangular, or any other suitable shape to accommodate different sizes and types of scent pods 12.

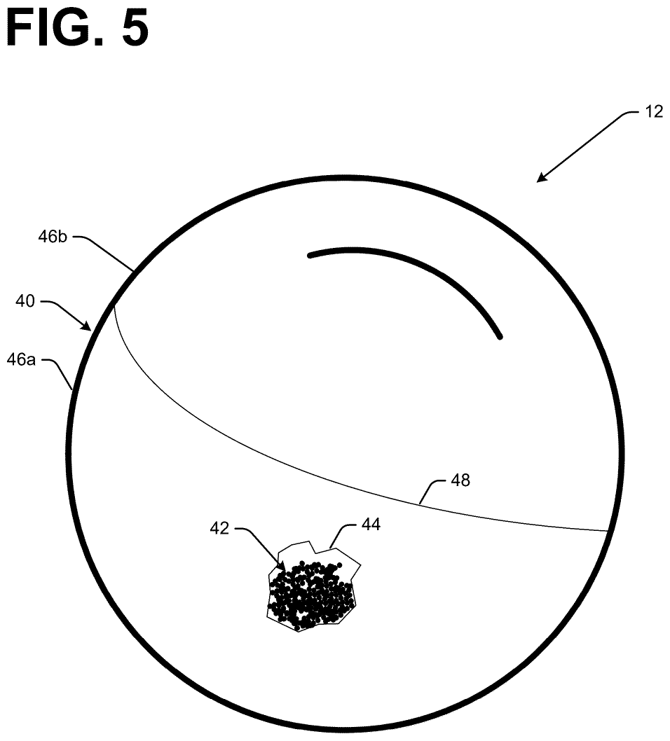

Implementing the pod structures 32a, 32b requires careful consideration of the size and material of the pod pockets 34a, 34b to help ensure it can hold the scent pod 12 without tearing, crushing or breaking open the scent pod 12. In the example shown in the drawings, the pouch 22 is configured to help ensure that the scent pod 12 is securely held during launch. In an example, the pod structures 32a, 32b operate together to at least partially encapsulate the scent pod 12 during drawing the retention cords 20a, 20b, and then open to release the scent pod 12 during launching, as will be described in more detail below with reference to FIGS. 5-7. This configuration of the pouch 22 helps to ensure that the scent pod 12 is securely held in place and does not break prematurely during launch. Alternatives can include using elastic materials, nets, or breakaway straps or hook-and-loop fasteners, for additional security in retaining the scent pod 12.

As already noted above, the launching device 14 may be implemented for delivering the scent pod 12 to a desired area. The scent pod 12 has a scent to be remotely dispersed. The scent pod 12 is the carrier that delivers the scent into the desired area without a person having to enter the desired area to deliver the scent. As such, the scent luring apparatus 10 described herein enables a user to put the desired scent of choice (e.g., for deer, elk, bobcat, etc.) out into the field, e.g., for the intent of attracting game for hunting or trapping, or for training hunting dogs. It is noted that different size, weight, shape and/or color of the scent pods 12 can be provided as indicators to the user of different applications for the scent pods 12. For example, the size, weight, shape and/or color or other features of the scent pod 12 itself may indicate the type of scent contained in the scent pod 12 (e.g., red is for attractant scents, white is for training scents), scent strength, type of animal, size of animal, size or area of hunting area covered by a scent pod 12, etc.

FIG. 5 shows an example scent pod 12. The example scent pod 12 includes an outer shell or casing 40, making it a structure for the filler or scent material 42 (illustrated through cutout 44). The casing 40 may have two portions (portion 46a and portion 46b separated as illustrated by line 48) that separate from one another for filling the scent pod 12. In another example, the casing 40 may be formed as a single unitary structure with an opening to add the filler or scent material, or the casing 40 may come prefilled (e.g., it is filled during manufacture). The casing 40 should be strong enough to withstand movement during storage and transport, and the launch itself, while still being able to open automatically upon impact (e.g., by popping open and/or breaking the casing 40). Filler or scent material 42 may include liquid, gel, beads, pellets and powdered substances, containing scents. Casing 40 can be made from biodegradable plastics or other environmentally friendly materials.

In an example, the casing 40 is made of gelatin. Gelatin is advantageous because it is biodegradable and dissolves easily upon impact, helping to ensure release of the scented material 42. However, other water-soluble polymers such as agar-agar or certain plant-based gels may also be used. The selection of material for the casing 40 will depend at least to some extent on design considerations, such as but not limited to the required durability and environmental considerations.

The filler or scent material 42 of the scent pod 12 retains and disperses scent effectively upon the opening of the outer shell 40. This can involve microencapsulation techniques where scented oils or particles are encapsulated within a material that releases the scent when broken. Other examples can include, but are not limited to scented wax or foam that disintegrates upon impact.

In an example, the scent pod 12 is a polyethylene glycol (PEG) sphere. PEG is chosen for its solubility and safety, making it a suitable option for dispersing scents. However, other water-soluble polymers like polyvinyl alcohol (PVA) may also be implemented, for example depending on the desired solubility rate and environmental impact.

In an example, the scented material 42 is nontoxic and/or biodegradable, to help ensure safety and environmental friendliness. This can be implemented using natural essential oils or biodegradable fragrance compounds. Other examples can include, but are not limited to synthetic fragrances that meet safety and biodegradability requirements.

In an example, the scent pod 12 is a gel or liquid or granular-filled capsule. The capsule may include a housing such as an outer shell or casing 40 with a filling (e.g., gel, liquid, and/or granular filling), similar to a medicinal pill. The outer shell or casing 40 may be made of a gelatin (e.g., animal collagen, or cellulose or other plant-based fiber). The filling includes the scented material 42 (and may also include other substance(s) such as a buffer or other fill material). The scented material 42 may be liquid, crystals, granules, powder, or any other substance that retains the scent and disperses the scent when the scented material 42 is released from the scent pod 12 upon breaking the outer shell 40. The outer shell 40 is configured to be sufficiently thick so as to not readily break during transport (e.g., in the handle) or delivery (e.g., being shot out of the launching device). The outer shell 40 is further configured to break open on impact (e.g., after being shot out of the launching device) with the ground, rocks, trees, or other impact surface. Upon impact, the outer shell 40 breaks or otherwise opens and the scented material 42 is dispersed to the surrounding environment to deliver the scent to a desired location or area (e.g., near a hunting blind or tree stand).

In an example, the scent pods 12 may be provided to the end-user already preconfigured and ready for use. That is, the scent pods 12 may be prefilled with the scented material. In another example, the outer shell 40 may be provided empty and the scent may be provided separately (e.g., in a bottle) for the end-user to add into the outer shell 40. The outer shell 40 may have separate parts (e.g., a first half 46a and a second half 46b) that can be filled or partially filled with the scented material 42 and then press-fit together to encapsulate the scented material therein.

The scent pod may be configured in various sizes, having various amounts and/or types of scented material 42 (e.g., to attract different types of animals), and/or with distinct colors (e.g., to visually indicate a type of scent). Example configurations of the scent pod 12 are described below with reference to Tables 1 and 2.

In the first example shown in Table 1, a 68 caliber scent pod (about 17.3 mm in diameter) has a capacity of about 3.00 grams. A single (1) ounce of scent material was measured to be about 28.35 grams. Corresponding scent pods that can be filled to various capacities are shown in the table.

TABLE 1
Example 68 Caliber Scent Pod Configurations

| Pod Fill | Mass of | Number Pods Filled |
|---|---|---|
| (% of Total Volume | Scented | (w/1 Oz |
| Filled with Scented | Material | Scented |
| Material) | Per Pod | Material) |
| 75% Filled | 2.25 grams | 12.6 pods |
| 50% Filled | 1.50 grams | 18.9 pods |
| 25% Filled | 0.75 grams | 37.8 pods |

In the second example shown in Table 2, a 50 caliber scent pod (about 12.7 mm in diameter) has a capacity of about 1.25 grams. A single (1) ounce of scent material was measured to be about 28.35 grams. Corresponding scent pods that can be filled to various capacities are shown in the table.

TABLE 2
Example 50 Caliber Scent Pod Configurations

| Pod Fill | Mass of | Number Pods Filled |
|---|---|---|
| (% of Total Volume | Scented | (w/1 Oz |
| Filled with scented | Material | Scented |
| Material) | Per Pod | Material) |
| 75% Filled | 0.9375 grams | 30.24 pods |
| 50% Filled | 0.6225 grams | 45.38 pods |
| 25% Filled | 0.3125 grams | 90.72 pods |

It is noted that the sizes, masses, percent fill, and other values shown in Tables 1 and 2 are provided only for purposes of illustration, and are not intended to be limiting of the disclosure herein.

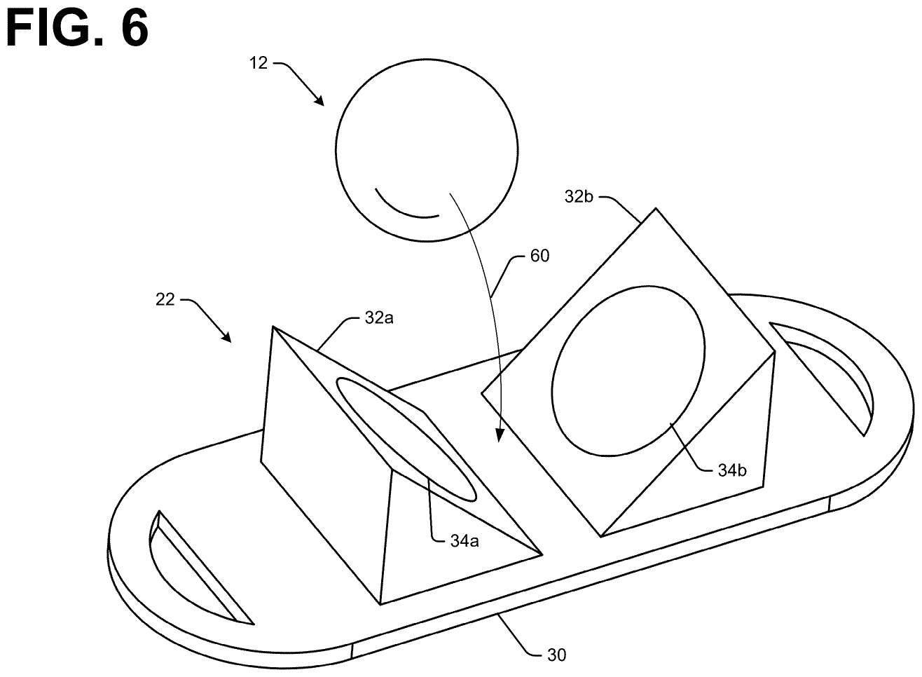

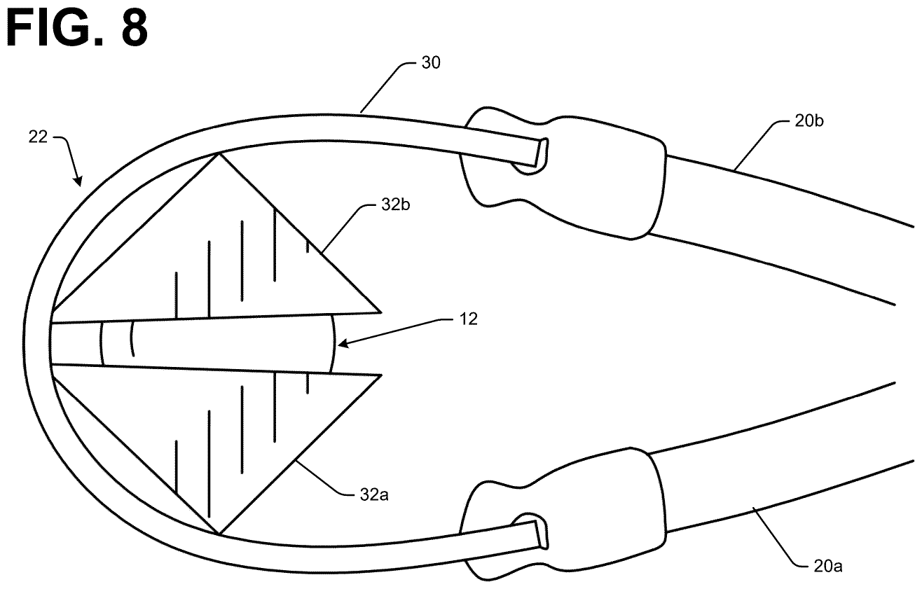

FIG. 6 illustrates loading the scent pod 12 into the pouch 22 of the launching device 14. FIG. 7 illustrates drawing back on the pouch 22 of the launching device 14. FIG. 8 is a top down view of the pouch 22 of the launching device 14 corresponding to FIG. 7, wherein the device is in the fully drawn back position and the pouch 22 at least partially encapsulates the scent pod 12 therein.

During operation, a user may insert a scent pod 12 in between (or into one of) the pod pockets 34a, 34b, as illustrated by arrow 60 in FIG. 6. The user may then grasp the base 30 of the pouch 22 and pull back in a direction that is away from the handle 16, as illustrated by arrow 50a in FIG. 7. FIG. 8 illustrates the device in the fully drawn back position wherein the pod pockets 34a, 34b are in a closed position. The pod pockets 34a, 34b are designed to at least partially encapsulate the scent pod 12 in the closed position, as illustrated in FIG. 8, helping to ensure that the scent pod 12 does not fall out during handling.

Implementing this requires precise engineering to balance the opening and closure mechanism of the pod pockets 34a, 34b. The pod pockets 34a, 34b are configured to transition from an open position to a closed position as tension is applied to the retention cords 20a, 20b (see, e.g., arrow 50a). This feature ensures that the scent pod 12 is only released when the tension is released. Tension can be released when the user lets go of the pouch 22 so that the scent pod 12 travels in the direction illustrated by arrow 50b; after having already drawn back on the pouch 22 as illustrated by arrow 50a in FIG. 7 (see also FIG. 8).

In an example, the scent pod 12 is released into the air and then breaks open on impact to disperse the scent material 42 (and hence the scent). As noted above, the scent material 42 (along with the casing 40 and other material in the casing 40, if any) can be nontoxic and/or biodegradable.

In an example, the scent pod 12 includes an attractant scent for hunting. In another example, the scent pod 12 includes a training scent for training a hunting dog. The scent luring device 10 allows hunters and trappers to deliver the scent pod 12 remotely from the user to distribute the scent without having to walk in the hunting area and avoid potentially contaminating that area with human scent.

It is noted that the examples shown and described are provided for purposes of illustration and are not intended to be limiting. Still other examples are also contemplated.

1. A scent luring apparatus, comprising:
a scent pod;
a scented material in the scent pod; and
a scent delivery mechanism to launch the scent pod to a location remote from the scent delivery mechanism, wherein the scent pod is configured to at least partially open upon impact to release at least some of the scented material from the scent pod.

2. The scent luring apparatus of claim 1, wherein the scent pod has a casing with a filling.

3. The scent luring apparatus of claim 2, wherein the casing is a gelatin.

4. The scent luring apparatus of claim 2, wherein the filling is at least in part a scented material that retains scent and disperses the scent when the scented material is released from the scent pod upon opening the outer shell.

5. The scent luring apparatus of claim 1, wherein the scent pod is a polyethylene glycol sphere.

6. The scent luring apparatus of claim 1, wherein the scented material is at least one of nontoxic and biodegradable.

7. The scent luring apparatus of claim 1, wherein the scent delivery mechanism is at least one of an air gun, a bow and arrow, a crossbow and bolt, and a slingshot.

8. The scent luring apparatus of claim 1, wherein the scent delivery mechanism is a launching device further comprising a handle, at least one arm attached to the handle, at least one retention cord attached to the at least one arm, and a pouch.

9. The scent luring apparatus of claim 8, wherein the pouch further comprises a base member attached on opposite ends to the at least one retention cord.

10. The scent luring apparatus of claim 9, further comprising at least one pod pocket on the base member of the pouch.

11. The scent luring apparatus of claim 10, wherein the at least one pod pocket defaults to an open position without tension on the at least one retention cord, and the at least one pod pocket transitioning to a closed position as tension is applied to the at least one retention cord.

12. The scent luring apparatus of claim 11, wherein the at least one pod pocket at least partially encapsulates the scent pod in the closed position.

13. The scent luring apparatus of claim 8, further comprising a chamber in the handle for storing the scent pod therein.

14. The scent luring apparatus of claim 8, further comprising a support structure having at least one support member attached to the handle and at least one brace member attached to the at least one support member, the brace member configured to fit adjacent a forearm of a person when the handle of the launching device is held in a hand of the person.

15. The scent luring device of claim 8, wherein the at least one retention cord is configurable with a variety of different bands, each band having a different color to visually indicate an elasticity of the band.

16. A scent luring apparatus, comprising:
a scent pod;
a scented material in the scent pod; and
a launching device to launch the scent pod to a location remote from the scent delivery mechanism, wherein the scent pod is configured to at least partially open automatically upon impact to release at least some of the scented material from the scent pod.

17. The scent luring apparatus of claim 16, wherein the launching device further comprises a handle, a first arm attached between a first side of the handle and to an end of a first retention cord, a second arm attached between a first side of the handle and to an end of a second retention cord.

18. The scent luring apparatus of claim 17, wherein the launching device further comprises:
a pouch having a base member attached on a first end to the first retention cord, and the base member attached on a second end to the second retention cord, the base member of the pouch extending between the first retention cord and the second retention cord; and
a first pod pocket on the base member of the pouch, and a second pod pocket positioned adjacent to the first pod pocket on the base member of the pouch.

19. The scent luring apparatus of claim 18, wherein the first and second pod pockets are separated from one another when tension in the first and second retention cords is released, and the first pod pocket moving toward the second pod pocket as tension is applied to the first and second retention cords to at least partially encapsulate the scent pod between the first and second pod pockets.

20. The scent luring apparatus of claim 16, wherein the scent pod has a gelatin outer shell for a scented material that retains scent and disperses the scent when the scented material is released from the scent pod upon opening the outer shell.
